(19) United States
(12) Patent Application Publication
(10) Pub. No.: US 2007/0060159 A1
(43) Pub. Date: Mar. 15, 2007

(54) Radio communication apparatus

(76) Inventors: Yoriko Utsunomiya, Tokyo (JP); Tomoko Adachi, Urayasu-shi (JP); Masahiro Takagi, Tokyo (JP); Tetsu Nakajima, Yokohama-shi (JP); Tomoya Tandai, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/385,736

(22) Filed: Mar. 22, 2006

(30) Foreign Application Priority Data
Sep. 14, 2005 (JP) 2005-267028

(51) Int. Cl. H04Q 7/20

(52) U.S. Cl. 455/450

(57) ABSTRACT

A radio communication apparatus includes an acquiring device which acquires information required to determine a ratio between a first period length making a radio communication by using either of two first channels each having a first bandwidth and a second period length making a radio communication by using a second channel having a second bandwidth wider than the first bandwidth. The second channel is overlapping with the two first channels. A determining device determines the ratio on the basis of the information, thereby determines the first period length and the second period length. Accordingly, a radio communication by using the first channel within the first period length and a radio communication by using the second channel within the second period length are performed.

### CROSS-REFERENCE TO RELATED APPLICATIONS

This application is based upon and claims the benefit of priority from prior Japanese Patent Application No. 2005-267028, filed Sep. 14, 2005, the entire contents of which are incorporated herein by reference.

### BACKGROUND OF THE INVENTION

1. Field of the Invention

The present invention relates to a radio communication to perform media access control (hereinafter, refereed to as MAC) on the basis of a carrier sense state, and more particularly to a radio communication in which a plurality of users share a plurality of channels.

2. Description of the Related Art

The MAC controls to decide how a plurality of communication apparatuses communicating by sharing the same media should use media and transmit communication data. With the MAC is performed, a phenomenon (so-called collision) that a communication apparatus on a reception side becomes impossible to separate the communication data is reduced even when more than two communication apparatuses simultaneously transmit the communication data by the use of the same media. The MAC also reduces a phenomenon that the media are not used by any communication apparatus regardless of presence of the communication apparatus waiting for a transmission request.

In a radio communication, since it is hard for a communication apparatus to monitor transmission data while transmitting data, the MAC not based on the premise of collision detection is needed. IEEE 802.11 that is a typical technology standard of a local area network (LAN) adopts carrier sense multiple access with collision avoidance (CSMA/CA).

The CSMA/CA in IEEE 802.11 sets a period (referred to as duration), until a sequence of one or more frame exchanges succeeding to a MAC frame is completed, to a header of the MAC frame. A communication apparatus which does not have any relation to the sequence and does not have a transmission right in the duration waits for a transmission by determining a virtual reservation state of the media. Thereby, an occurrence of the collision is avoided. In contrast, a communication apparatus which have the transmission right knows that the media is not used now except for the period with the media are actually occupied therein.

The regulations in IEEE 802.11 determines states of the media by combining a virtual carrier sense of such a MAC layer of the former communication apparatus and physical carrier sense of such a physical layer of the latter communication apparatus and performs the MAC on the basis of the determination.

A method for providing a radio base station possible to be shared by a plurality of wireless LAN systems in a radio communication system with a plurality of wireless LAN systems different in physical layer coexisted therein is disclosed in Jpn. Pat. Appln. KOKAI No. 2003-87856. More specifically, the radio base station alternately generates a first notification signal in a first physical layer and a second notification signal in a second physical layer to transmit them to a radio terminal and synchronizes with the first and the second notification signals to switch the first and the second physical layers. Then, the radio terminal corresponding to the first second physical layer can access to the radio station only for a fixed time period from the transmission time of the first notification signal and the radio terminal corresponding to the second physical layer can access to the radio station only for a fixed time period from the transmission time of the second notification signal.

IEEE 802.11 adopting the CSMA/CA has attained a high communication speed by changing mainly a protocol of a physical layer. For a 2.4 GHz band, IEEE 802.11 has changed in its communication speed, from IEEE 802.11 (communication speed of 2 Mbps, established in 1997) to IEEE 802.11b (communication speed of 11 Mbps established in 1999), and further to IEEE 802.11g (communication speed of 54 Mbps, established in 2003). For a 5 GHz band, only IEEE 802.11a (communication speed of 54 Mbps, established in 1999) has been defied as standard.

As one approach for achieving the high communication speed, if we depend on a method for expanding a frequency bandwidth of a channel, we have to perform the MAC for different channels coexisting in the same frequency band. In this case, the communication apparatus can separate a period of a narrow-band communication with a single channel used therein from a period of a wide-band communication with a plurality of channels used therein, in accordance with the MAC to reserve a plurality of frequency channels one by one in turn, that is, the communication apparatus can achieve a high-speed communication in a wide-band.

However, when separating a period of a narrow-band communication and a period of a wide-band communication, the communication apparatus needs to sufficiently examine how to decide each length of communication periods. If each length of the communication periods is set inappropriately, an entire system is probably deteriorated in throughput.

For example, dynamic control for each length of the communication periods on the basis of each channel use rate between the narrow-band communication and the wide-band communication is a possible approach. However, since wireless LAN systems in actual environments each differ in feature of terminal configurations, propagation environments, etc. In accordance with basic service sets (BSS), the communication apparatus cannot always properly set each length of the communication periods on the basis of only the channel use rate.

### BRIEF SUMMARY OF THE INVENTION

One aspect of the present invention is directed to a radio communication apparatus including an acquiring device which acquires information required to determine a ratio between a first period length making a radio communication by using either of two first channels each having a first bandwidth and a second period length making a radio communication by using a second channel having a second bandwidth wider than the first bandwidth. The second channel is overlapping with the two first channels. A determining device determines the ratio on the basis of the information, thereby determines the first period length and the second period length. Accordingly, a radio communication by using the first channel within the first period length and a radio communication by using the second channel within the second period length are performed.

### BRIEF DESCRIPTION OF THE SEVERAL VIEWS OF THE DRAWING

FIG. 1 is a view showing a configuration of a radio communication apparatus according to embodiments of the present invention;

FIG. 2 is a view showing another configuration of the radio communication apparatus according to embodiments of the present invention;

FIG. 3 is a view for explaining a network configuration according to the embodiment of the present invention;

FIG. 4A and FIG. 4B are schematic views of channels in the network configurations, respectively;

FIG. 5 is a view for explaining a MAC system according to embodiments of the present invention;

FIG. 6 is a view showing a configuration of an access point (AP) according to a first embodiment of the present invention;

FIG. 7 is a view showing another configuration of the AP according to the first embodiment of the present invention;

FIG. 8 is a view for explaining time ratio control between a 20M_ch period and a 40M_ch period according to the first embodiment of the present invention;

FIG. 9 is a view for explaining the time ratio control between the 20M_ch period and the 40M_ch period according to the first embodiment of the present invention;

FIG. 10 is a view for explaining the time ratio control between the 20M_ch period and the 40M_ch period according to the first embodiment of the present invention;

FIG. 11 is a view for explaining time ratio control between a 20M_ch period and a 40M_ch period according to a second embodiment of the present invention;

FIG. 12A and FIG. 12B are views showing a determination example of a time ratio between a 20M_ch period and a 40M_ch period according to a third embodiment of the present invention;

FIG. 13 is a view showing a configuration of a 40M AP according to a fourth embodiment of the present invention; and

FIG. 14 is a view for explaining time ratio control between a 20M_ch period and a 40M_ch period according to the fourth embodiment of the present invention.

### DETAILED DESCRIPTION OF THE INVENTION

Hereinafter, embodiments of the present invention will be described with reference to the drawings.

A wireless communication system for searching frequency channels prior to communications includes a wireless LAN system on the basis of IEEE Std 802.11-1999 [revision 2003 includes ISO/IEC 8802-11, 1999(E) ANSI/IEEE Std 802.11, 1999 edition, IEEE Std 802.11a-1999, IEEE Std 802.11b-1999, IEEE Std 802.11b-1999/Cor. 1-2001 and IEEE Std 802.11d-2001]. Hereinafter, a basic system configuration will be explained on the basis of IEEE 802.11 wireless LAN system. IEEE 802.11 standard is the standard related to a physical (hereinafter, referred to as PHY) layer and a media access control (MAC) layer. The following processing will be described by mainly paying attention to processing in the MAC layer. IEEE 802.11 standard described herein includes standards positioned as amendments and recommended practices of IEEE 802.11 standard.

### First Embodiment

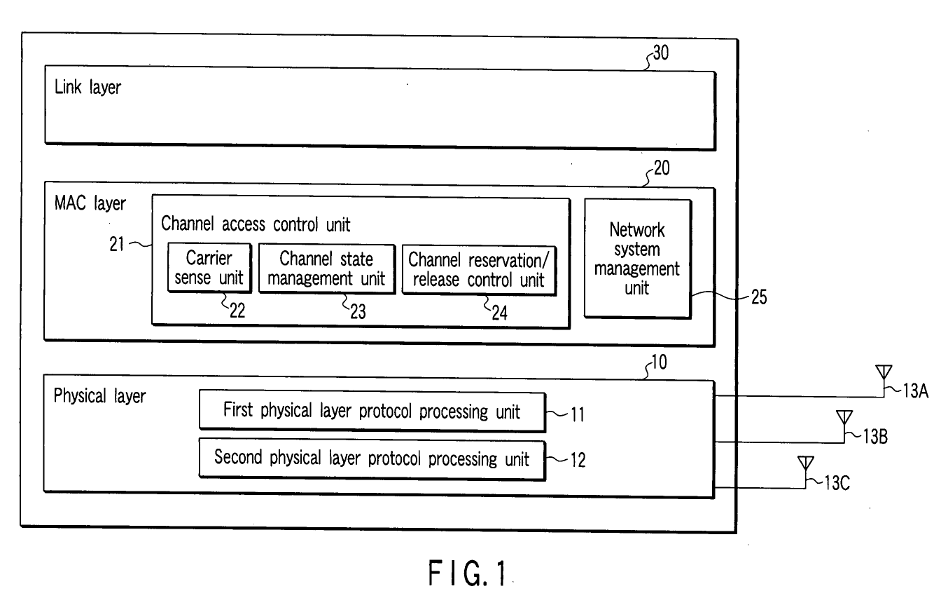

FIG. 1 shows a configuration of a terminal according to the first embodiment. As shown in FIG. 1, a radio communication apparatus according to the first embodiment mainly comprises a PHY layer 10, a MAC layer 20 and a link layer 30. In FIG. 1, the PHY layer corresponds to two kinds of PHY layer protocols differing in frequency bandwidth of channels to be used. That is, the PHY 10 has a first PHY layer protocol processing unit 11 to perform PHY layer protocol processing for communicating by use of a first channel having a first communication bandwidth; and a second PHY layer protocol processing unit 12 to perform PHY layer protocol processing for communicating by use of a second channel having a second communication bandwidth. Practically, the first and the second processing units 11 and 12 frequently share a circuit therebetween and they are not always independent from each other.

The protocol to be processed by the first processing unit 11 includes at least the PHY layer protocol defined by IEEE 802.11a. The first communication bandwidth used by the first processing unit 11 is set, for example, to 20 MHz. The first processing unit 11 may use a so-called multiple input multiple output (MIMO) technique which uses a plurality of antennas 13A-13C on a transmission side and on a reception side, respectively. The MIMO technique is a technique which has a high probability to be adapted to IEEE 802.11 task group n (TGn) intending further higher throughput of IEEE 802.11 because the MIMO technique can expect an increase in transmission amount almost proportional to the number of antennas while maintaining the frequency bands constant.

The second processing unit 12 is assumed to utilize either or both techniques of, for example, a single input single output (SISO) and the MIMO. The second communication bandwidth used by the second processing unit 12 is set to, for example, 40 MHz. The first communication bandwidth is present within the second communication bandwidth.

The MAC layer 20 has a channel access control unit 21, including a carrier sense unit 22, a channel state management unit 23 and a channel reservation/release control unit 24. The MAC layer 20 further has a network system management unit 25 which performs generation of a beacon frame, management of an association, or the like to appropriately expand a network system.

The carrier sense unit 22 manages an idle/busy state of a channel by managing a carrier sense state in accordance with a combination of actual carrier sense information acquired from the PHY layer 10 and virtual carrier sense possible to be acquired by the protocol of the MAC layer 20. In other words, the carrier sense unit 22 does not manage the idle/busy state of a single channel but manages idle/busy states of more than one first channel having the first communication bandwidth and more than one second channel having the second communication bandwidth.

One of the first channels among a plurality of first channels each having the first communication bandwidth may referred to as a ‘control channel’ and the other of the first channels may referred to as a ‘expansion channel’.

The reservation/release control unit 24 generates frames to control the virtual carrier sense state of the MAC layer needed to occupy a channel for a fixed period or release an occupied channel. The frames generated from the reservation/release control unit 24 are sent to the PHY layer 10 and transmitted through the first protocol processing init 11 and the second protocol processing unit 12.

The management unit 23 cooperatively operates the carrier sense unit 22, reservation/release control unit 24 and the first and second protocol processing units 11 and 12 of the PHY layer 10 so as to control the desired channel access.

A part of the above-mentioned constituent components can be achieved as a radio communication program to make a computer execute a prescribed procedure. The communication program is stored in a program storage device in the computer. The storage device comprises, for example, a nonvolatile semiconductor storage device, a magnetic disc device, etc. The communication program is stored in a random access memory (RAM) through control from a CPU (not shown) to be executed by the CPU.

A complete example of the radio communication apparatus shown in FIG. 1 includes, for example, a 40M/20M MIMO STA (AP) and a 40M/20M STA (AP). The 40M/20M MIMO STA (AP) is a terminal (or access point) possible to transmit/receive an SISO through a 20 MHz channel, a MIMO through the 20 MHz channel, an SISO through a 40 MHz channel and an MIMO through the 40 MHz channel. The 40M/20M STA (AP) is a terminal (or access point) possible to transmit/receive the SISO through the 20 MHz and the MIMO through the 40 MHz channel. The link layer 30 has a function of a usual link layer defined in IEEE 802.

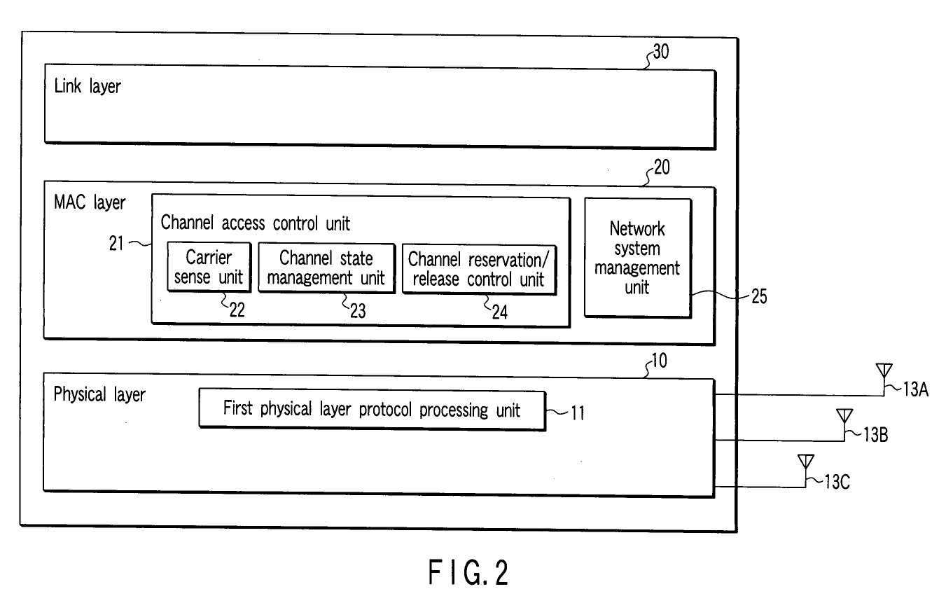

Another radio communication apparatus shown in FIG. 2 is different from the radio communication apparatus shown in FIG. 1 at a point that the PHY layer 10 does not include the second protocol processing unit 12 shown in FIG. 1. The another radio communication apparatus is in common with the radio communication apparatus shown in FIG. 1 at a point that a first communication bandwidth of the first protocol processing unit 11 is ostensibly 20 MHz and either cases of including or not including the MIMO technique can be acceptable and also in common with it at a point of the MAC layer 20 and the link layer 30.

However, since the radio communication apparatus in FIG. 2 only performs the MAC based on the first protocol processing unit 11, the detailed operations of the MAC layer 20 in FIG. 2 partially differs from the radio communication apparatus shown in FIG. 1. If the first protocol processing unit 11 does not include the MIMO technique, the radio communication apparatus in FIG. 2 may be an existing apparatus corresponding to at least one of IEEE 802.11a, IEEE 802.11b and IEEE 802.1g.

A specific example for the radio communication apparatus shown in FIG. 2 is, for example, a 20M MIMO STA (AP) and a 20M STA (AP). The 20M MIMO STA (AP) includes a terminal (or access point) enabled to transmit/receive an SISO through a 20 MHz channel and an MIMO through a 20 MHz channel.

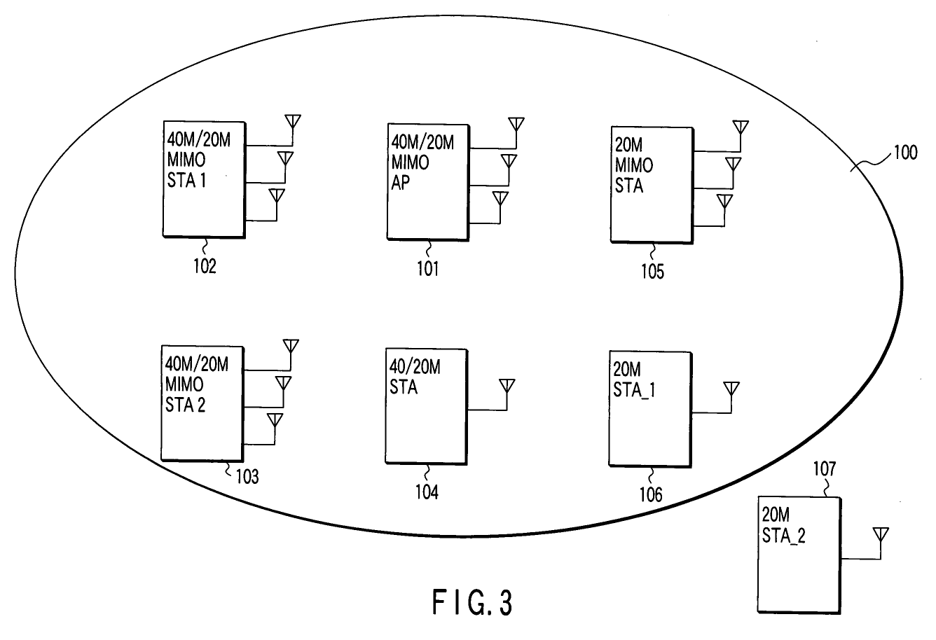

FIG. 3 shows an example of a network including the radio communication apparatuses in FIGS. 1 and 2. A base station 101 in the network is an AP corresponding to the 40M/20M MIMO AP. Each terminal establishes an association with the base station 101. Here, kinds of the terminals are a 40M/20M MIMO STA_{—}1 (102), 40M/20M MIMO STA_{—}2 (103), 40M/20M STA (104), 20M MIMO STA (105) and 20M STA_{—}1 (106). It is supposed for a 20M STA_{—}2 (107) to belong to a network other than the network 100, for example, a network using a channel 20M_ch_b.

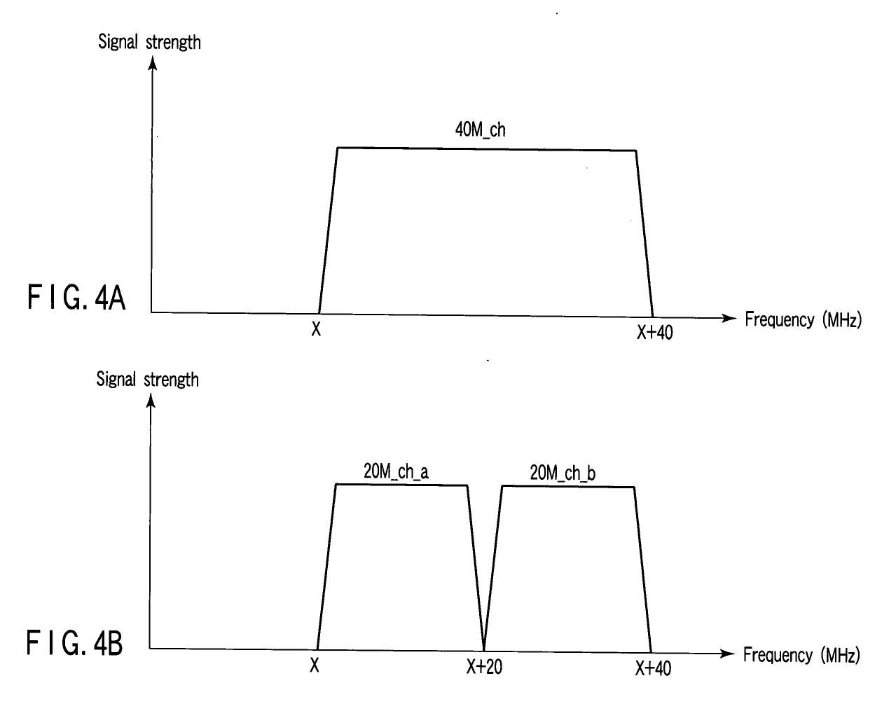

The network in FIG. 3 includes a channel 20M_ch_a of 20 MHz using a frequency band of X MHz to (X+20) MHz and a channel 40M_ch of 40 MHz using a frequency band of X MHz to (X+40) MHz as schematically shown in FIGS. 4B and 4A, respectively. Accordingly, the frequency band of X MHz to (X+20) MHz is utilizes in a channel of 20 MHz and a channel of 40 MHz with an overlap. The network 100 in FIG. 3 does not utilize another channel 20M_ch_b of 20 MHz using a frequency band of (X+20) MHz to (X+40) MHz, but other networks utilize it sometimes. Like this manner, the channels 20M_ch_a and 20M_ch_b are not used simultaneously. The network 100 uses the channel 10M of 40 MHz and either the two 20 MHz channels 20M_ch_a or 20M_ch_b overlapped in frequency of the channel 40M_ch. In other words, it is presumed that the 40M/20M MIMO STA and the 40M/20M STA belonging to the network 100 do not treat the channels 20M_ch_a and 20M_ch b simultaneously.

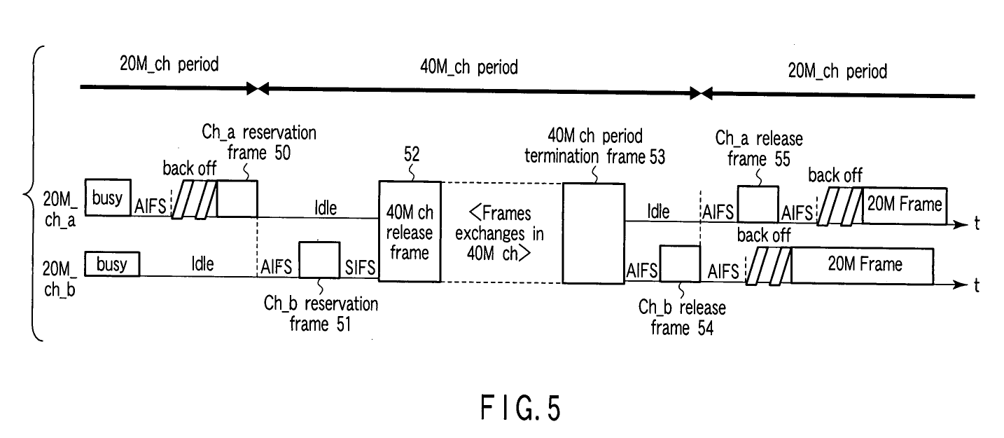

The first embodiment, specifically, takes the MAC in the network 100 shown in FIG. 3 into account. FIG. 5 shows, in time-series, a summary of exchanges of main frames necessary for the MAC. In the example in FIG. 5, the MAC controls switching between a period in which the 40M/20M MIMO AP that is the base station 101 communicates by using the channel 20M_ch_a (20M_ch_a period) and a period in which the 40M/20M MIMO AP communicates by using the channel 40M_ch (40M_ch period). During the 20M_ch_a period and the 40M_ch period, both of a mode (PCF or HCCA) by which the base station 101 performs the MAC by polling the terminals 102-106 and a mode (DCF or EDCA) by which each terminal 102-106 evenly performs the MAC are available.

FIG. 5 shows an aspect in which the radio communication apparatus communicates by using the channel 20M_ch_a firstly in the network 100, and after this, it returns to the channel 20M_ch_a again passing through the 40M_ch period. In the network 100, the radio communication apparatus utilizes both the channels 20M_ch_a and 40M_ch, however, the channel 20M_ch_b with the frequency overlapped with the channel 40M_ch used therein is disabled to be used so that the radio communication apparatus utilizes the channel 40M_ch. The channel 20M_ch_b might be used in another network adjacent to the network 100 or might not be used at all.

Operation procedures will be described by referring to FIG. 5 below. At the first time point, the 40M/20M MIMO AP, 40M/20M MIMO STA, 40M/20M STA, 20M MIMO STA (20M_ch_a) and 20M STA (20M_ch_a) are operated in the channel 20M_ch_a. The 20M MIMO STA (20M_ch_b) and 20M STA (20M_ch_b) are operated in the channel 20M_ch_b.

In this state, it is assumed that the channel state management unit 23 determines to start a procedure by which the base station 101 (40M/20M MIMO AP) to switch the channel now in use to the channel 40M_ch. The carrier sense unit 22 of the 40M/20M MIMO AP determines that the channel 20M_ch_a becomes into an idle state and that the continuation of the idle state for a PCF inter frame space (PIFS) period satisfies an idle condition of the channel 20M_ch_a. When receiving a determination result of satisfaction of the idle condition of the channel 20M_ch_a from the carrier sense unit 22, the channel reservation/release control unit 24 generates a frame (hereinafter, referred to as Ch_a reservation declaration frame) 50 to declare occupying the channel 20M_ch_a for a first fixed period to transmit it through the channel 20M_ch_a by use of the first PHY layer protocol processing unit 11. The frame 50 simultaneously notifies the fact that the operation mode of the network 100 will be switched from the channel 20M_ch_a to the channel 40M_ch. When receiving the Ch_a reservation declaration frame 50, the 20M MIMO STA (20M_ch_a) and 20M STA (20M_ch_a) set a busy state over a period with the carrier sense state of the MAC layer of the channel 20M_ch_a specified therein. The frame 50 has transmitted in the channel 20M_ch_a, so that the 20M MIMO STA (20M_ch_b) and the 20M STA (20M_ch_b) do not receive the frame 50.

The base station 101 (40M/20M MIMO AP), next, switches the PHY mode to the channel 20M_ch_b. After this switching, the 40M/20M MIMO AP waits until the idle state has lasted for the PIFS period to transmit a frame (hereinafter, referred to as Ch_b reservation declaration frame) 51 to declare occupying the channel 20M_ch_b for a second fixed period.

The base station 101 further waits until the idle state has lasted for the SIFS period to transmit a frame (hereinafter, referred to as 40M_ch release frame) 52 to release the channel 40M_ch that has occupied.

When receiving the release frame 52, the 40M/20M MIMO STA and 40M/20M STA set the carrier sense state of the MAC layer of the channel 40M_ch to an idle state over a specified period. After this, the radio communication apparatus secures media by means of usual media accesses to exchange frames in the channel 40M_ch.

Procedures to switch a mode which performs communications using the 40 MHz channel (40M_ch) into a mode which performs communications using the 20 MHz channel (20M_ch) in the network 100 will be described by referring to FIG. 5. The period in which the 40M/20M MIMO AP communicates by using the channel 40M_ch is called a 40M_ch period and the period in which it communicates by using the channel 20M_ch is called a 20M_ch period.

As shown in FIG. 5, it does not a matter for the 40M/20M MIMO AP to transmit a frame explicitly notifying the termination of the 40M_ch period (hereinafter, referred to as 40M_ch period termination frame) 53. When receiving the termination frame 53, the 40M/20M MIMO STA and 40M/20M STA make the carrier sense state of the MAC layer of the channel 40M_ch be a busy state to switch the PHY mode to the channel 20M_ch_a. The carrier sense state of the MAC layer of the channel 20M_ch_a has been still in the busy state, and then the 40M/20M MIMO STA and 40M/20M STA cannot still transmit the frame of the channel 20M_ch_a. By the way, here are possible procedures as follows: The 40M/20M MIMO AP does not explicitly transmit the 40 MHz_ch period termination frame but notifies a 40 MHz_ch period length to the 40M/20M MIMO STA and the 40M/20M STA in advance by a ch_a reservation frame and a ch_b reservation frame, and then, when a scheduled time for the 40 MHz_ch period termination comes, the 40M/20M MIMO STA and 40M/20M STA bring the carrier sense of the MAC layer of the channel 40M_ch into the busy state to switch the PHY mode into the channel 20M_ch_a.

The 40M/20M MIMO AP then transmits a frame (hereinafter, referred to as Ch_b release frame) 54 to release the reservation state of the channel 20M_ch_b. By setting the reservation period of the channel 20M_ch_b to be terminated successively to the termination of the 40M_ch period in advance, the reservation period of the channel 20M_ch_b may be terminated naturally. When receiving the release frame 54, or when the reservation period of the channel 20M_ch_b terminating naturally, the 20M MIMO STA (20M_ch_b) and 20M STA (20M_ch_b) set the carrier sense state of the MAC layer of the channel 20M_ch_b to an idle state. Thereby, the 20M MIMO STA (20M_ch_b) and 20M STA (20M_ch_b) can start frame exchange of the channel 20M_ch_b.

The 40M/20M MIMO AP then switches the PHY mode to the channel 20M_ch_a to transmit a frame (hereinafter, referred to as Ch_a release frame) 55 to release the reservation state of the channel 20M_ch_a. By setting the reservation period of the channel 20M_ch_a to terminate successively to the termination of the 40M_ch period and the termination of the reservation period of the channel 20M_ch_b in advance, the reservation period of the channel 20M_ch_a may be terminated naturally. The 40M/20M MIMO STA and 40M/20M STA which have already switched to the channel 20M_ch_a and the 20M MIMO STA (20M_ch_a) and 20M STA (20M_ch_a) now in operation in the channel 20M_ch_a, when they receive the release frames 55 or when the reservation period of the channel 20M_ch_b is terminated naturally, they set the carrier sense state of the MAC layer of the channel 20M_ch_a to an idle state. Thereby, the 40M/20M MIMO STA, 40M/20M STA, 20M MIMO STA (20M_ch_a) and 20M STA (20M_ch_a) can start the frame exchanges in the channel 20M_ch_a.

Hereinafter, an example of adaptive control of a time ratio between the 20M_ch period and the 40M_ch period in the case of use of the MAC system shown in FIG. 5 will be explained.

For making the adaptive control of the time ration between the 20M_ch period and the 40M_ch period, it is necessary for the 40M/20M MIMO AP to determine the time ratio between the 20M_ch period and the 40M_ch period and to transmit the declaration frame 50, declaration frame 51, release frame 52, termination frame 53, release frame 54 and release frame 5 in FIG. 5 at transmission timing based on the determined time ratio. After transmitting the declaration frames 50, 51 and release frame 52 in FIG. 5 at the transmission timing based on the determined time ratio, the 40M/20M MIMO AP does not have to transmit the termination frame 53, release 54 and release 55. In this case, with the determined time ratio or the length of the 40 MHz_ch period described and transmitted in the declaration frames 50 and 51, the 40M/20M MIMO STA and 40M/20M STA brings the carrier sense state of the MAC layer voluntarily into the busy state to switch the PHY mode to the channel 20M_ch_a.

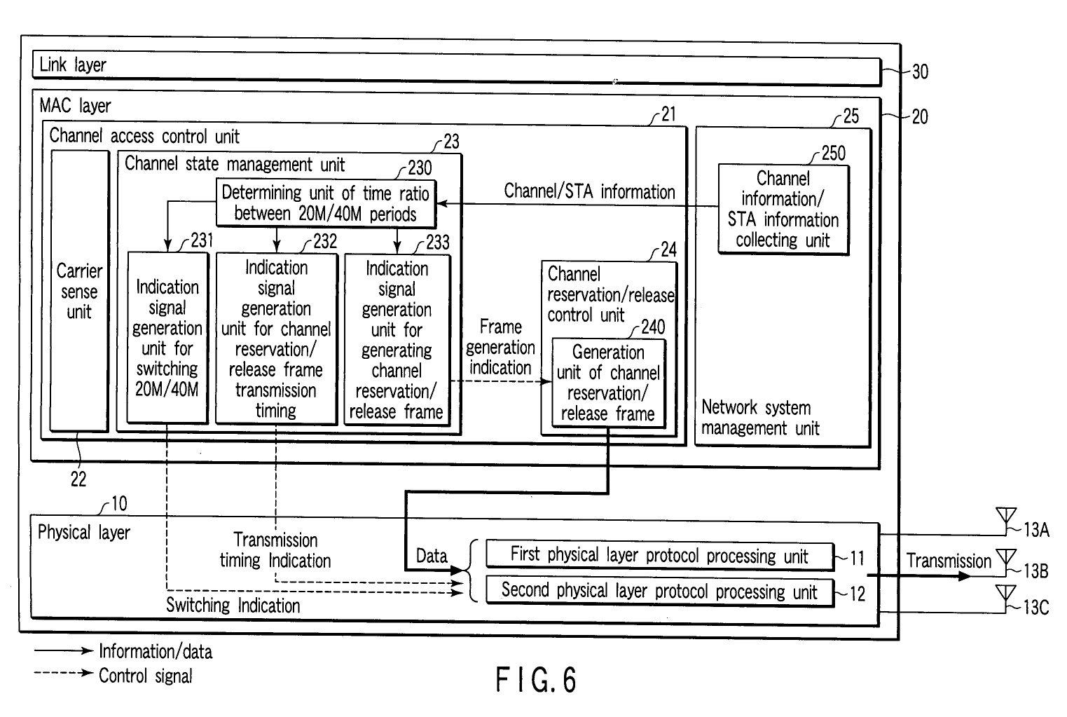

FIG. 6 shows a configuration of a 40M AP to intensively manage the network 100. A network management unit 25 in the 40M AP collects channel information on the channels 20M_ch and 40M_ch or STA information in the network 100 (channel information/STA information collecting unit 250). A channel state management unit 23 in a channel access control unit 21 determines time lengths of the 20M_ch period and 40M_ch period or the tone ratio between the 20M_ch and the 40M_ch period (determining unit 230 of a time ratio between 20M/40M periods).

An indication signal generation unit 233 for generating a channel reservation/release frame generates a control frame to switch the 20M_ch period and the 40N_ch period in the MAC layer 20, that is, an indication signal to instruct the generation of the declaration frame 50, declaration frame 51, release frame 52, termination frame 53, release frame 54 and release frame 55 to the channel reservation/release control unit 24, in accordance with the determined time ratio. A frame generation unit 240 of the reservation/release control unit 24 generates these declaration frame 50, declaration frame 51, release frame 52, termination frame 53, release frame 54 and release frame 55 according to the indication signal to transfer them to the PHY layer 10.

Similarly, the channel state management unit 23 transmits a 20/40M switching indication signal and a transmission timing indication signal of a channel reservation/release frame to the PHY layer 10 according to the determined time ratio.

The PHY layer 10 switches a first PHY protocol and a second PHY protocol in accordance with the switching indication signal from an indication signal generation unit for switching 20M/40M 231. And the PHY layer 10 transmits the declaration frame 50, declaration frame 51, release frame 52, termination frame 53, release frame 54, and release frame 55 in FIG. 5 according to transmission timing indication signals from an indication signal generation unit for channel reservation/release frame transmission timing 232 of the state management unit 23.

A termination method of a time ratio between a 20M_ch period and a 40M_ch period at the 40M AP will be described by referring to the case in which a beacon interval (beacon interspace) is divided into a 20M_ch period and a 40M_ch period as an example.

The state management unit 23 in the 40M AP, firstly, collects or measures information needed to determine the time ratio between the 20M_ch period and the 40M_ch period. Here, the information necessary for determining the time ratio between the 20M_ch period and the 40M_ch period is supposed, for example, to utilize the number of terminals of the 20M STAs and 40M STAs existence in the network 100. The information is not limited to the number of terminals; the state management unit 23 can use information such as traffic amounts in the channels 20M_ch and 40M_ch, throughput, frame transmission success rates and channel states other than the number of terminals.

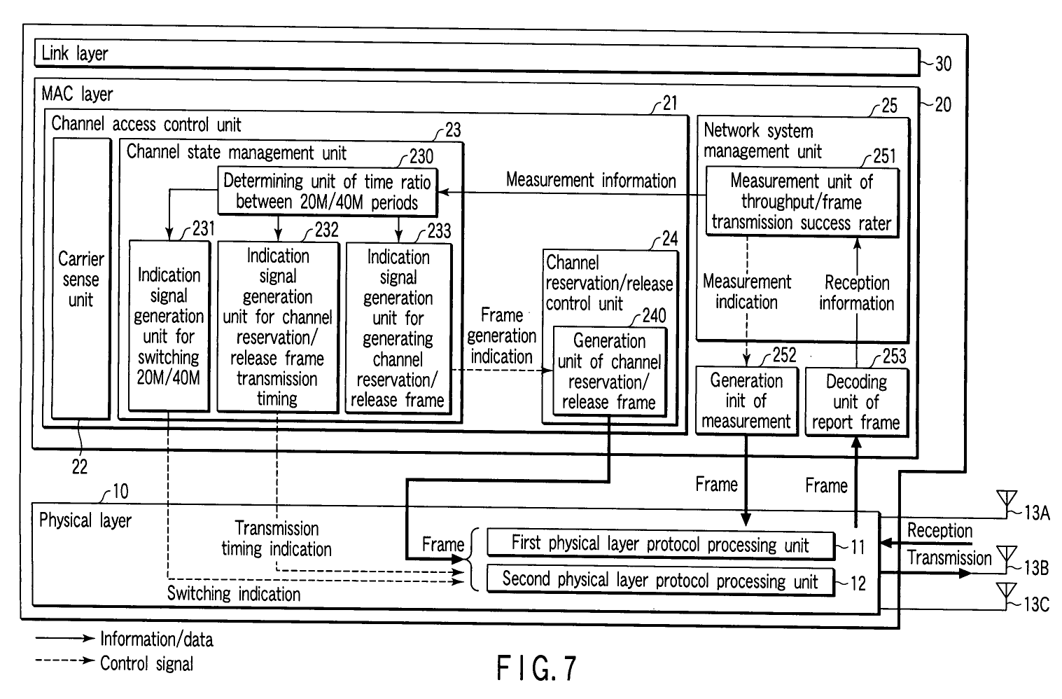

Having shown the configuration view of the AP in the case where the information necessary for determining the time ratio between the 20M_ch period and 40M_ch period is collected in FIG. 6, another configuration of the AP will be shown below. The configuration in FIG. 6 has shown the case of collection of channel information/STA information by the AP; however, in FIG. 7, the AP measures a throughput/frame transmission success rate instead of the channel information/STA information in another configuration.

In the configuration in FIG. 6, the channel state management unit 23 determines the time ratio between the 20M_ch period and 40N_ch period by using the channel information/STA information which is collected by the collecting unit 250 in the network system management unit 25 in advance if necessary. In contrast, in FIG. 7, a measurement unit of throughput/frame transmission success rate 251 of the system management unit 25 instructs measurement when information is needed then a measurement frame generating unit 252 generates measurement frames to transmit it to other STAs. A decoding unit of report frames 253 receives report frames replied from other STAs. The measurement unit 251 measures, for example, the throughput and the success rate on the basis of the reception information to send the measurement information to the channel state management unit 23. A time ratio determining unit between 20M/40M period in the state management unit 23 determines the time ratio between the 20M_ch period and 40M_ch period in accordance with the measurement information acquired from the measurement unit 251.

After determining the time ratio in the state management unit 23, as described above, the MAC generates the Ch_a reservation declaration frame 50, Ch_b reservation declaration frame 51, 40M_ch release frame 52, 40M_ch period termination frame 53, Ch_b release frame 54 and Ch_a release frame 55 then the PHY layer 10 transmits them in accordance with the transmission timing instructed from the state management unit 23.

Hereinafter, examples of a method for collecting information by the network system management unit 25 and of a method for determining the time ratio between the 20M_ch period and 40M_ch period by the channel state management unit 23 will be described.

When subscribing to the network 100, each STA transmits an association/probe request frame to the AP managing the network 100. An ability type of each STA, in other words, whether each STA is a 20M STA or a 40M STA is described in the association/probe request frame. The AP has stored the numbers of the 40M STAs and 20M STAs under control in a counter, and when receiving an association/probe request frame to approve the subscription of the STAs, the AP counts up the counter corresponding to the ability types of the newly subscribed STAs.

On the other hand, when leaving from the network 100, each STA sends a disassociation request frame to the AP. When receiving disassociation request frames, the AP counts down the counter corresponding to the types of the STAs to be disconnected. The AP may transmit the disassociation request frames to the STAs because the STAs do not perform communications for a fixed period or do not reply to the AP. The transmission of the disassociation request frames has shown that the counter corresponding to the ability types when the STAs are disconnected from the network 100. Regardless of the transmission of the disassociation request frame, when an STA does not make a communication for a fixed period, the STA is presumed that it has already receded from the network 100, and similarly, the counter is probably treated to be count down. Each STA can collect peripheral terminal information to report it to the AP by use of the standard such as IEEE 802.11k. The AP collects reports transmitted from each STA to record the numbers of the 40M STAs and 20M STAs under control.

Thereby, the AP grasps the numbers of the 40M STAs and 20M STAs under control and can record them in the network system management unit 25.

Based on the information on the numbers of the 40M STAs and 20M STAs under control, the AP determines the time ratio between the 20M_ch period and 40M_ch period. An appropriate policy decides how to control the time ratio between the 20M_ch period and 40M_ch period on the basis of the number of terminals. For example, if the numbers of the 40M STAs and 20M STAs are the same as each other and if it is intended that the radio communication apparatuses using the channels 20M_ch and 40M_ch use the media as evenly as possible, the AP controls the time ratio so as to make a beacon interval to be expressed by a ratio of, for example, 40M_ch period: 20M_ch period=50%:50%.

The AP controls the time ratio so that the 20M_ch period becomes relatively short and the 40M_ch period becomes relatively long to give a priority to the channel 40M_ch over the channel 20M_ch. On the contrary, when the channel 20M_ch is given a priority over the channel 40M_ch, the AP controls the time ratio so that the 20M_ch period becomes relatively long and the 40M_ch period becomes relatively short.

If the number of the 40M STAs is larger than that of the 20M STAs, the AP controls the time ratio so that the 20M_ch period becomes relatively short and the 40M_ch period becomes relatively long. On the contrary, the AP controls the time ratio so that the 20N_ch period becomes relatively long and the 40M_ch period becomes relatively short.

The channel state management unit 23 in the AP determines the time ratio on the basis of the information on the number of the STAs and the policy to adaptively control the time ratio between the 20M_ch period and 40M_ch period.

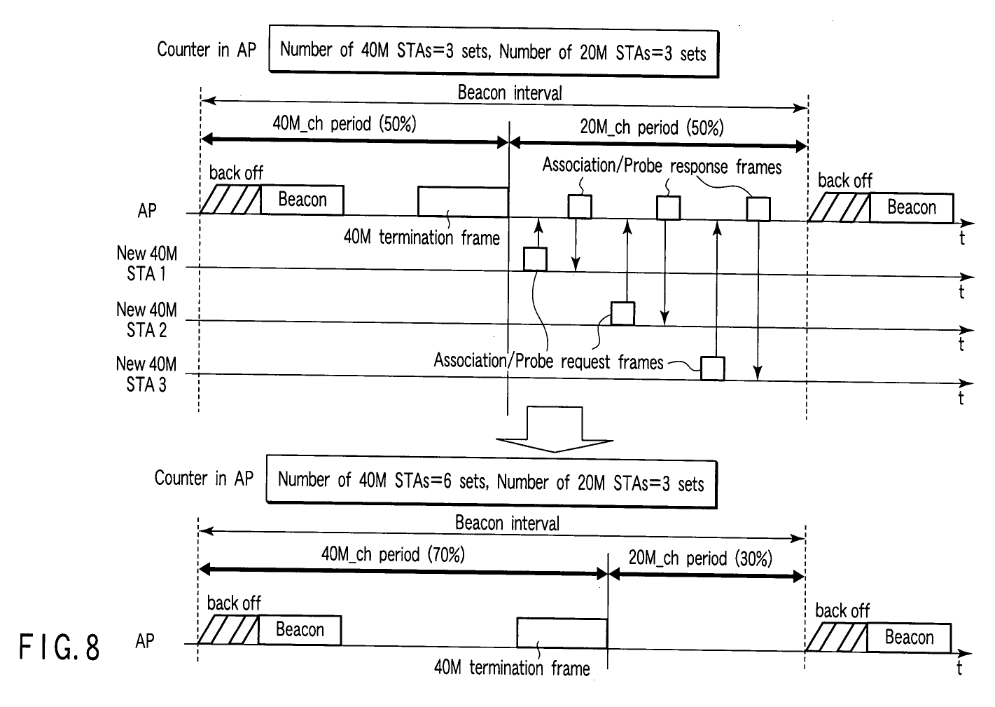

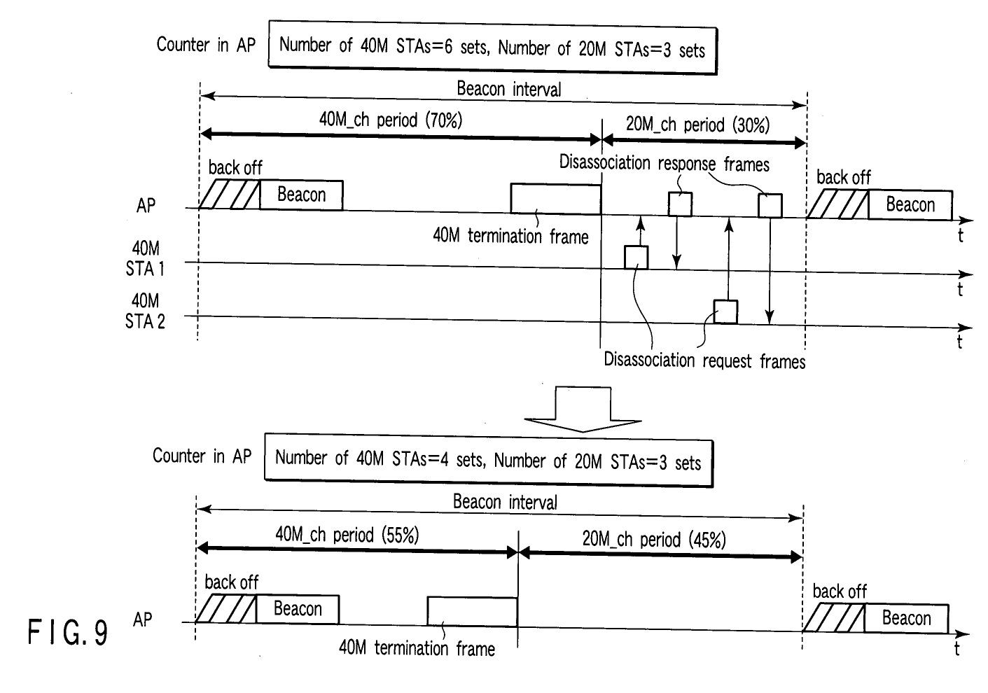

FIGS. 8 and 9 show examples in which the AP controls the 20M_ch periods and 40M_ch periods in response to the numbers of the 40M STAs and 20M STAs, respectively. At first, it is assumed that three sets of the 40M STAs and three sets of the 20M STAs belong to the network managed by the AP. Assuming that the AP manages the network in accordance with the policy that the communication apparatus using the channel 20M_ch and the communication apparatus using the channel 40M_ch can each use media as evenly as possible, this case brings the number of the 40M STAs and that of the 20M STAs into the same number, so that the 40M STAs and 20M STAs divide one beacon interval into 50% each to use them, respectively. However, the AP needs not always set the time ratio between the 20M_ch period and 40M_ch period to a ratio equal to that of the number of the STAs by taking the fact that a 20 MHz communication has a slower transmission speed and takes a longer time to transmit one frame into account. For example, if frames have the same numbers of bits one another; it takes approximately a double of a transmission time to transmit them through the 20 MHz in comparison to the case of the transmission through the 40 MHz. Accordingly, the control which comes into effect the following ratio: 40M_ch period: 20M_ch period=(50−α)%: (50+α)% (α is arbitrary integer) has a potential to make the communication apparatuses each using the channels 20M_ch and 40M_ch use the media equally.

Here, it is supposed that three sets of the 40M STAs have transmitted the association/probe request frames to the AP and subscribed to the network. The AP checks the ability types of the STAs described in the request frames to count up the counter for counting the number of the 40M STAs. Based on the updated information on the number of STAs, the AP determines the time ratio between the 20M_ch period and 40M_ch period in the next beacon interval. Since the number of the 40M STAs becomes six and the number of the 20M STAs becomes three because the 40M STAs has subscribed newly, the AP divides one beacon interval so that, for example, the 40M_ch period becomes 70% and the 20M_ch period becomes 30% (refer to FIG. 8). The AP may set the time ratio between the 20M_ch period and 40M_ch period to the same ratio as that of the number of the STAs and may set values in which the lengths of the 40M_ch and 20M_ch periods are adjusted to be added a minus value and a plus vale, respectively, by taking differences in transmission speeds as described above.

Furthermore, if two sets of the 40M STAs have transmitted the disassociation request frames to the AP and have left from the network, then, the AP receives the request frames to counts down the counter for counting the number of the 40M STAs. Based on the updated information on the number of the STAs, the AP decides the time ratio between the 20M_ch period and 40M_ch period in the next beacon interval. At this time, since the number of the 40M STAs has decreased, the AP control so as to make the 40M_ch period become shorter (refer to FIG. 9).

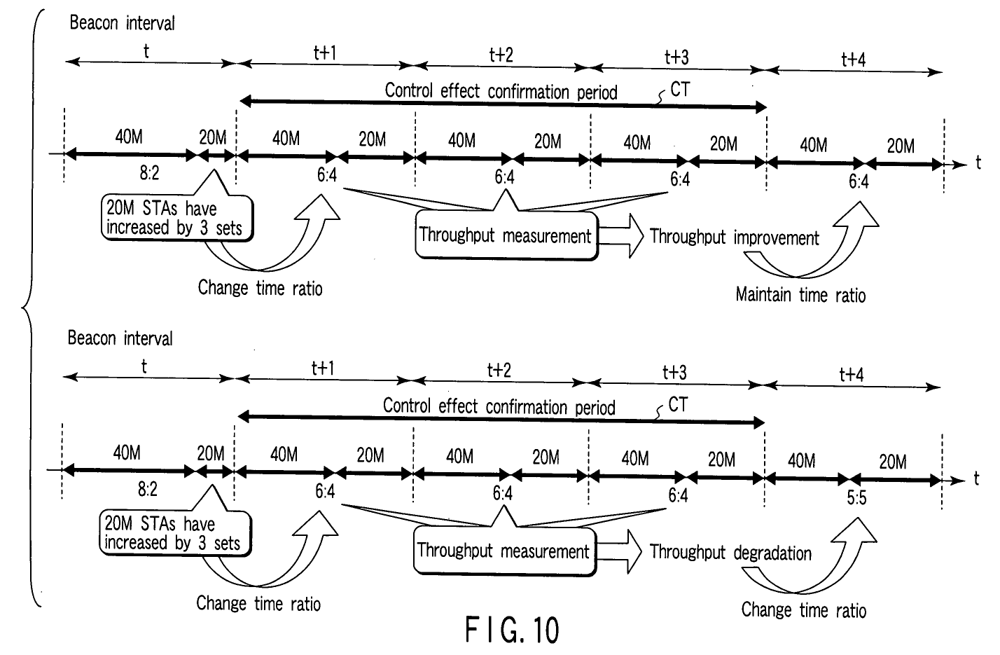

As shown in FIG. 10, the AP possibly controls the time ratio between the 20M_ch period and 40M_ch period by setting a control effect confirmation period CT. Indexes for the confirmation of the control effect include, for example, the use of the throughput and the frame transmission success rate.

An example using the throughput will be described below. It is presumed that the AP changes the time ratio between the 20M_ch period and 40M_ch period in a certain beacon interval ‘t’. The AP sets ‘t+T’ (T is appropriate integer) after the interval ‘t’ as the control effect confirmation period CT to measure the throughput at the 20M_ch period and 40M_ch period, respectively. If a total of the throughput at the measured 20M_ch period and 40M_ch period has improved in comparison with the time ratio therebetween before change, the AP determines that the time ratio has been adjusted properly and divides one beacon interval into the 20M_ch period and the 40M_ch period with the successive use of the time ratio after change.

In contrast, if the total of the throughput of the measured 20M_ch period and 40M_ch period has decreased in comparison with the time ratio between the 20M_ch period and 40M_ch period before change, the AP determines that the time ratio has been adjusted improperly and restores the 20M_ch period and 40M_ch period to the time ratio before change or resets it to another time ratio.

With such a control effect confirmation period CT in FIG. 10 used, the AP firstly and roughly sets the time ratio between the 20M_ch period and the 40M_ch period and can adjust them while confirming them by means of index such as throughput. Or, with an appropriate time ratio calculated by means of an algorithm or a calculation formula from the beginning, the AP can adjust the time ratio without having to use the confirmation period CT. And a method combining both adjustments is possible one. It depends on accuracy of the algorithm or the calculation formula to introduce the time ration between the 20M_ch period and the 40M_ch period whether the confirmation period CT is needed or not. If the algorithm or the calculation formula is excellent in control accuracy, it is possibly acceptable not to provide the confirmation period CT, and if it is poor in the control accuracy, it is possibly preferable to control the time ratio while confirming its control effect by providing the confirmation period CT with the time ratio control.

Further, here is a possible method, wherein the AP does not determine the time ration between the 20M_ch period and the 40M_ch period by means of the algorithm or calculation formula, but the AP prepares default ratios in advance as some options and selects an appropriate value among them to use it. For example, six options: (40M_ch period): (20M_ch period)=10:0, 8:2, 6:4, 4:6, 2:8 and 0:10 are prepared. If the time ratio is expressed by the ratio: (40M_ch period): (20M_ch period)=8:2, it is supposed that three sets of the 20M STAs have newly subscribed to increase the 20M STA in number. Based on the newly updated number of the terminals, the AP selects, for example, the ratio of (40M_ch period): (20M_ch period)=6:4 among the six options to control each communication period to match with this time ratio.

Like this manner, the AP can control the time ratio between the 20M_ch period and the 40M_ch period in response to the numbers of the 20M STAs and the 40M STAs under control.

### Second Embodiment

Because a second embodiment is basically similar to the first embodiment, the second embodiment will be intensively described the point deferring from the first embodiment. The different point is that the first embodiment assumes to control the 20M_ch period and 40M_ch period depending on the number of the STAs but the second embodiment controls them by traffic amounts not by the number of the STAs.

The AP firstly collects information on a data amount stored in transmission queues of each STA. Here, we will describe the case of a wireless LAN system using the standard of IEEE 802.11e as an example. Each STA compliant with IEEE 802.11e standard describes size of transmission data (transmission queue size) actually stored in a QoS control field to transmit data frames. The AP collects sizes of the transmission queues from the data frames transmitted from each STA to grasp transmission data amounts stored in each STA.

For using a polling system such as an HCF controlled channel access (HCCA) as an MAC system, the AP can grasp the traffic amounts of the 40M STAs and 20M STAs form the number of transport streams (TSs) and required band widths of each TS. When expecting to be assigned a band periodically by polling from the AP, each STA transmits a pole transmission request frame to the AP. An averaged data rate of transmission scheduled data is described in this request frame. When enabling securing the band required from each STA, the AP replies a pole transmission approval reply frame to the STA. With this negotiation performed, the AP can grasp the number of establishments of band assignments by the pole transmissions (number of TS) and the band widths to be assigned to each STA. The AP, as mentioned for the first embodiment, has grasped ability types (40M STA or 20M STA), so that it can grasp the transmission data amounts of the 20M STA and 40M STA individually.

With such IEEE 802.11k standard used, each STA can also report the transmission data amount stored in its own terminal to the AP. The AP collects reports transmitted from each STA to respectively record the transmission data amounts stored in the 40M STAs and 20M STAs under control. Thereby, the AP can grasp the traffic amounts of the 40M STAs and 20M STAs under control.

The AP then determines the time ratio between the 20M_ch period and 40M_ch period on the basis of traffic amount information of the 40M STAs and 20M STAs under control. As a method for determining the time ration, for example, the following calculation Formula 1 is available.

$$( 40 MHz communication period length ) \text{:} ( 20 MHz communication period length ) = {\sum }_{i = 1}^{m} \frac{Li}{Ri} \text{:} {\sum }_{j = 1}^{n} \frac{Lj}{Rj} \qquad ( 1 )$$

Wherein, m is the number of the STAs by the use of 40 MHz and n is the number of the STAs by the use of 20 MHz. And Li is a transmission data amount stored in an i-th 40 MHz STA and Lj is a transmission data amount stored in a j-th 20 MHz STA. Assuming that Ri is an averaged PHY transmission rate in a 40 MHz communication and Rj is an averaged PHY transmission rate in a 20 MHz communication, one beacon interval T can be divided by the ratio calculated by Formula 1.

This Formula 1 obtains bandwidths necessary for transmissions from the transmission data amounts stored in the 40M STAs and 20M STAs, respectively, and divides one beacon interval in response to the ratio of the obtained bandwidths.

When the number of TSs and required bandwidths of each TS are used for controlling the time ratio between the 20M_ch period and 40M_ch period, the following method is available.

The AP calculates a data amount transmitted in one beacon interval for averaged transmission data rate described in the pole transmission request frame from the STAs to calculate required bandwidths for each TS.

The AP totals the required bandwidths of each TS of the 20M STAs and 40M STAs, respectively, and divides one beacon interval in response to its ratio of the totaled bandwidths. The calculation Formula 2 is as follows:

$$( 40 MHz communication period length ) \text{:} ( 20 MHz communication period length ) = {\sum }_{i = 1}^{m} \frac{Li \cdot T}{Ri} \text{:} {\sum }_{j = 1}^{n} \frac{Lj \cdot T}{Rj} \qquad ( 2 )$$

Wherein, m is the number of the STAs of 40 MHz and n is the number of the STAs of 20 MHz. And assuming that Li is an averaged transmission data rate at which an i-th STA using 40 MHz notifies in a TS, Lj is an averaged transmission data rate at which a j-th STA using 20 MHz notifies in a TS and T is one beacon interval length, data amounts scheduled to be transmitted in the one beacon interval are represented in Li×T(bit), and Lj×T(bit), respectively. Assuming that Ri is an averaged PHY transmission rate in the 40 MHz communications and Rj is an averaged PHY transmission rate in 20 MHz communications, the one interval rate T may be divided by the ratio calculated by Formula 2.

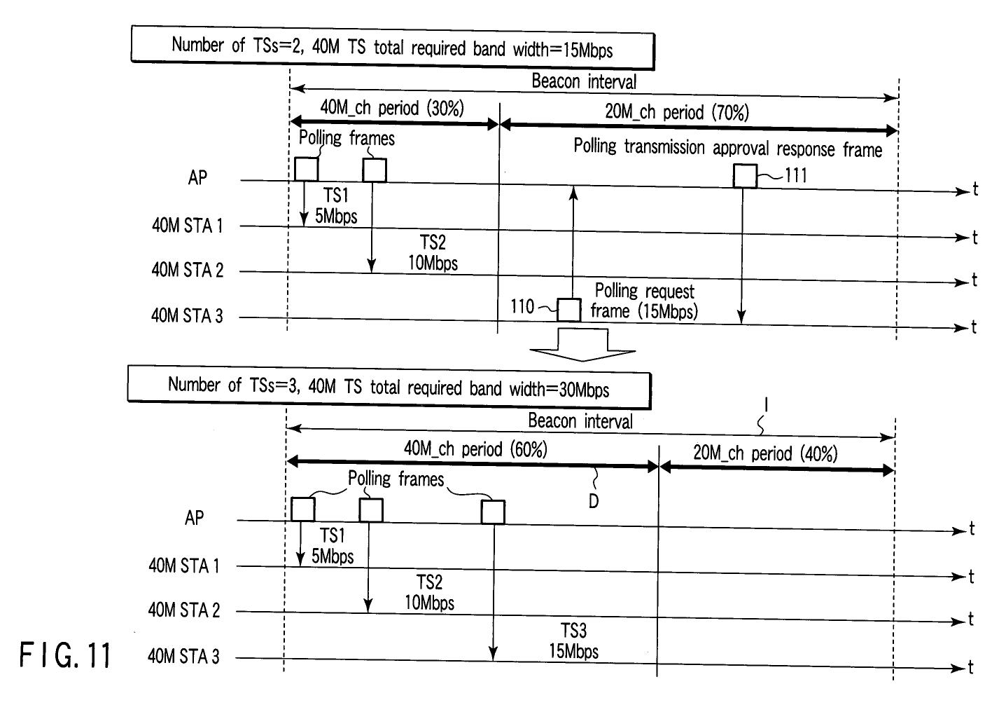

FIG. 11 shows an aspect of the time ratio control between the 20M_ch period and 40M_ch period, based on the number of TSs and required bandwidths of each TS in the use of the HCCA. In FIG. 11, it is presumed that, for example, the HCCA is utilized as a media access system for the 40M_ch period and an enhanced distributed channel (EDCA) is utilized as a media access system for the 20M_ch period. A 40M STA1 and a 40M STA2 firstly establish a TS 1 of 5 Mbps and a TS 2 of 10 Mbps, respectively. At that time, a 40M STA3 transmits a pole request frame 110 to establish a TS of 15 Mbps to the AP. Request conditions which requires to assign a TS necessary for conducting a transmission with an averaged data rate of 15 Mbps to the 40M STA3 are described in the request frame 110. The AP checks the request, and if it is possible to assign a band as required, it replies a pole transmission approval response frame 111 to the 40M STA3. In the case of FIG. 11, the AP confirms that an idle band of the 20M_ch period is in existence by 15 Mbps or more to reply the response frame 111 to the 40M STA3.

In the next beacon interval, since the number of the TSs of the 40M STAs becomes three and a total required bandwidth of the TSs increases up to 30 Mbps, the AP controls so that a 40M_ch period length D becomes to, for example, 60% of one beacon interval I. The AP can also control, like this manner, the time ratio between the 20M_ch period and 40M_ch period in response to increase and decrease in the number of the TSs and the required bandwidth of the 40M STA. As described above, the AP can control the time ratio between the 20M_ch period and the 40M_ch period in response to the increase and decrease of the traffic amounts of the 40M STAs and 20M STAs under control.

### Third Embodiment

Since a third embodiment is basically similar to the first embodiment, the third embodiment will be selectively described the point deferring from the first embodiment. The different point is that the first embodiment assumes to control the 20M_ch period and 40M_ch period depending on the number of the STAs but the third embodiment controls them by channel states. The channel state in the third embodiment means, for example, presence or absence of interference from other communications which are detected in scanning the channel state.

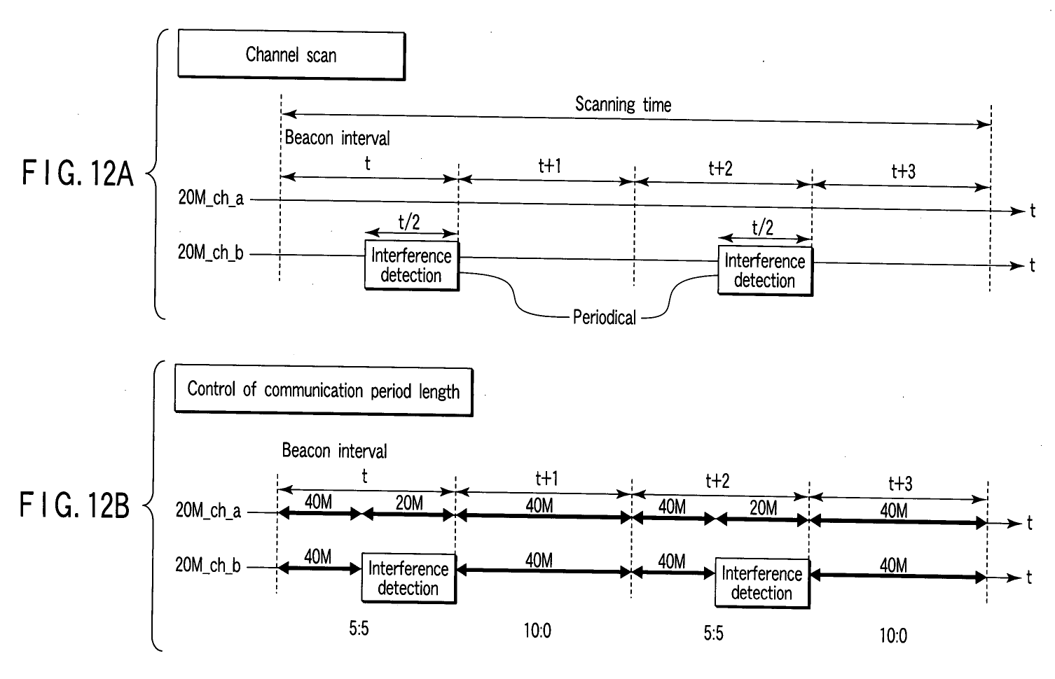

FIGS. 12A and 12B show examples of determining the time ratios between the 20M_ch period and 40M_ch period depending on channel states, respectively.

FIG. 12A shows the case in which the AP detects interference at a fixed cycle on the channel 20M_ch_b in channel scanning. Such an interference source is a radar. Assuming that the AP makes the 40 MHz communication using both the channels 20M_ch_a and 20M_ch_b during a period in which it has not detected the interference and makes the 20 MHz communication only using the channel 20M_ch_a during a period in which it has detected the interference (FIG. 12B).

In the examples in FIGS. 12A and 12B, each AP detects one piece of interference by a length of ½ of a beacon interval on the channel 20M_ch_b at every two beacon interval. Accordingly, the AP divides beacon intervals t, t+2, . . . , in which the interference is predicted to occur, into time ratios: (40M_ch period): (20M_ch period)=5:5, respectively, and sets beacon intervals t+1, t+3, . . . , in which the interference is predicted not to occur, to time ratios: (40M_ch period): (20M_ch period)=10:0, respectively.

Even another case, for example, where the interference is detected on the channel 20M_ch_a or where the interference occurs not periodically, the AP can control the time ratio between the 20M_ch period and 40M_ch period on the basis of the channel states by setting a period with no interference like the above-described manner.

### Fourth Embodiment

Because a fourth embodiment is basically similar to the first embodiment, the fourth embodiment will be intensively described the point deferring from the first embodiment. The different point is that the first embodiment assumes to control the 20M_ch period and 40M_ch period depending on the number of the STAs but the fourth embodiment controls them in response to requests from the STAs.

Having described methods by each of which the AP leads to control the time ratio between the 20M_ch period and 40M_ch period on the basis of the collected information in the embodiments in FIG. 1 to FIG. 3, respectively, the time ratio is changed by being taken the initiative in requesting from the STAs to the AP.

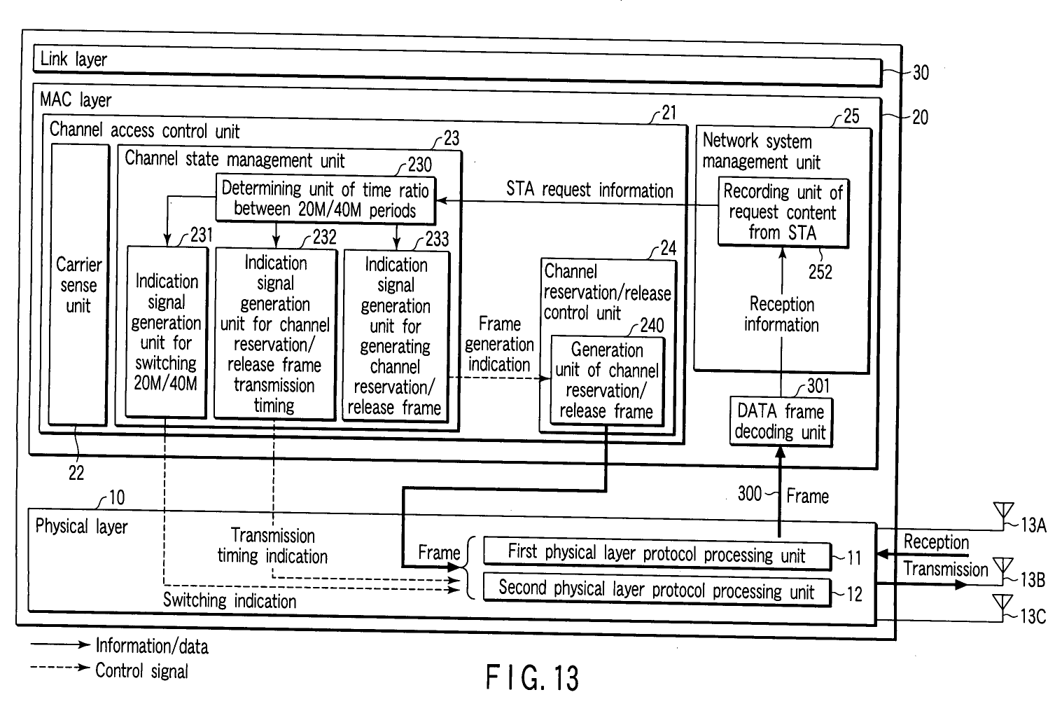

FIG. 13 shows a configuration of the 40M AP making concentrated management of the network 100. When receiving a time ratio changing request frame 300 from the STA, the network system management unit 25 in the 40M AP decodes the frame 300 by a data frame decoding unit 301 and records its request content in a recording unit 252. Based on the request content, the channel state management unit 23 (time ratio determining unit 230 between 20M/40M periods) in the channel access control unit 21 determines the time lengths of the 20M_ch period and 40M_ch period or time ratio between the 20M_ch period and 40M_ch period. The indication signal generation unit for generating a channel reservation/release frame 233 instructs the control frames to switch the 20M_ch period and 40M_ch period in the MAC layer 20, namely the generation of the Ch_a reservation declaration frame 50, Ch_b reservation declaration frame 51, 40M_ch release frame 52, 40M_ch period termination frame 53, Ch_b release frame 54 and the Ch_a release frame 55, in accordance with the determined time ratio, to the channel reservation/release control unit 24. According to the indication, the reservation/release control unit 24 generates these frames 50-55 to transfer them to the PHY layer 10.

In a similar manner, a 20/40M switching indication signal and a transmission timing indication signal of channel reservation/release frame are transmitted from the channel state management unit 23 to the PHY layer 10.

The PHY layer 10 switches the first PHY layer protocol and second PHY layer protocol in accordance with the indication from the channel state management unit 23 and transmits the Ch_a reservation declaration frame 50, Ch_b reservation declaration frame 51, 40M_ch release frame 52, 40M_ch period termination frame 53, Ch_b release frame 54 and Ch_a release frame 55 in FIG. 5 in response to the transmission timing instructed from the sate management unit 23.

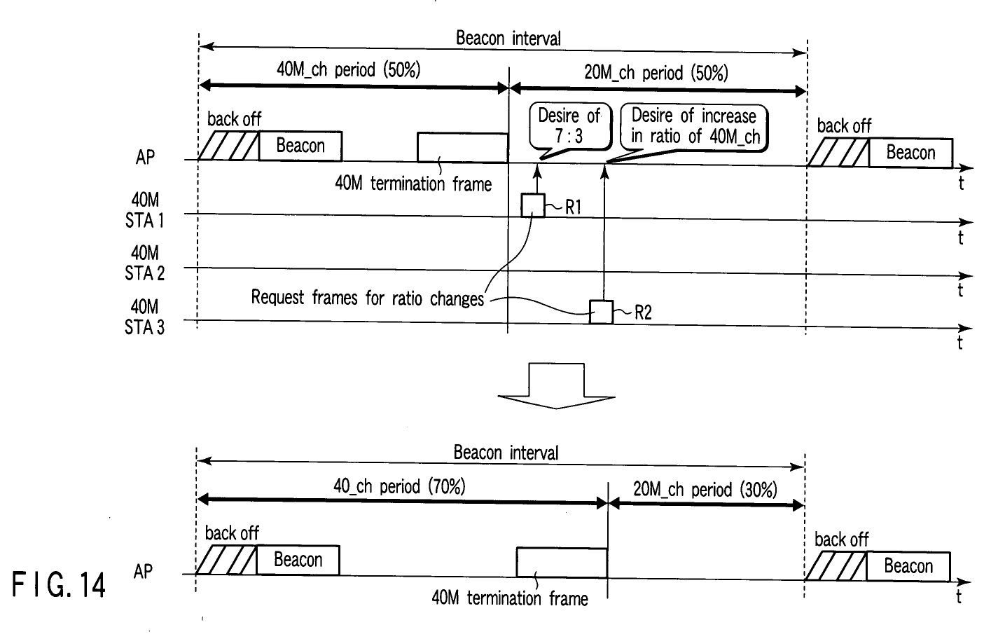

FIG. 14 shows the time ratio control between the 20M_ch period and 40M_ch period based on the request from the STA.

In the case of the time ratio between the 20M_ch period and 40M_ch period is 5:5, it is presumed that the STA 1 and STA 3 are not satisfied with the ratio of 5:5. The STA 1 and STA 3 then transmit a frame R1 and a frame R2 requiring the change of the ratio of the channel periods, respectively, to notify the fact that they ate not satisfied with the current ratio to the AP. The ratio change request frames R1 and R2 may describe desired ratios and concrete numerical values of desired bandwidths therein, respectively. Or, the frames R1 and R2 may describe only requests desiring to merely make the 40M_ch period longer or shorter in comparison with a current one. Or, the frames R1 and R2 may require desired ratios by preparing default ratios as some potions in advance and by notifying optional numbers of the ratios desired by the STA 1 and STA 3 among the options. Furthermore, the frames R1 and R2 may describe types or levels of importance of data scheduled to be transmitted to prioritize the necessity of the change in the ratio.

The AP checks the number of the STAs now requesting the changes in the ratio or the contents of the requests then determines how to change the time ratio between the 20M_ch period and 40M_ch period or whether or not change the current ratio to maintain as it is. When receiving requests for the change in the ratio from many STAs, or when receiving a change request frame with high importance, the AP determines to change the current ratio. The AP determines how to change the ratio on the basis of the request contents described in the frames R1 and R2. The AP may follow the contents of a change request with high importance and also may control the change in accordance with the change contents requested from many STAs. And the AP cannot entirely satisfy requests from all the STAs but possibly changes the ratio so as to satisfy 80% of all the STAs.

A method is a possible approach, which provides, for example, a time ratio change request field in a data frame as a substitute for using a special frame such as a change request frame and describes a time ratio change request between the 20M_ch period and 40M_ch period in the data frame to notify the change request from the STA to the AP. For example, a field of 1-bit is prepared in a MAC header and the state of the filed of ‘0’ indicates to maintain the current ratio, and the state of the filed of ‘1’ indicates to desire the change in the current ratio. In the case of use of 2-bit field, the method may define that in 1-bit field, ‘0’ indicates the maintenance of the current ratio and ‘1’ indicates the change request thereof, and in the remaining 1-bit, ‘0’ indicates the ratio increase request of the 40M_ch period and ‘1’ indicates the ratio decrease request thereof. As such a field, it is possible to utilize a reserved bit prepared in the MAC header.

Or, a method is also another possible approach, which uses a 2-bit as numeric figures from 0 to 3 together, prepares default ratios as some options in advance and specifies the ratio desired by the STA among the options. This method prepares, for example, four options, namely (40M_ch period): (20M_ch period)=8:2 (No. 0), 6:4 (No. 1), 4:6 (No. 2) and 2:8 (No. 3). Each STA describes the numeric figures from 0 to 3 in the data frame by using the 2-bit field, and for example, if the second is described therein, the AP understands that the STA desires the ratio of (40M_ch period): (20M_ch period)=4:6.

The AP controls the time ratio between the 20M_ch period and 40M_ch period in accordance with desires from each STA. For example, when there are many STAs which select the ratios making the 40M_ch period longer as substitutes for the current ratio, the AP controls the 40M_ch period to become longer. In contrast, when many STAs select the ratios to make the 40M_ch period shorter, the AP controls the 40M_ch period to become shorter. If a few STAs which select the ratios different from the current ratio, the AP may continuously use the current ratio, however the AP controls the ratios not to maintain as they are but changes them, as the number of STAs which select the ratios different from the current ones becomes larger. In the case in which the STAs of, for example, 50% or more among the STAs under control select the options deferring from the current ratio, the AP reviews to change the ratio.

As mentioned above, the leading requests from the STAs to the AP make it possible to change the time ratio between the 20M_ch period and 40M_ch period.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio communication apparatus, comprising:
an acquiring device configured to acquire information required to determine a ratio between a first period length making a radio communication by using either of two first channels each having a first bandwidth and a second period length making a radio communication by using a second channel having a second bandwidth wider than the first bandwidth, the second channel overlapping with the two first channels;
a determining device configured to determine the ratio on the basis of the information, thereby to determine the first period length and the second period length; and
a device configured to make a radio communication by using the first channel within the first period length and to make a radio communication by using the second channel within the second period length.

2. The radio communication apparatus according to claim 1, wherein the information represents the number of terminals making radio communications by using one of the first channels and the number of terminals making radio communications by using the second channel.

3. The radio communication apparatus according to claim 1, wherein the information represents a traffic amount of the radio communication using one of the first channels and a traffic amount of the radio communication using the second channel.

4. The radio communication apparatus according to claim 1, wherein the information represents at least one state which indicates idle or busy in any of the first channels and the second channel during the period of radio communication by using one of the first channels, and at least one state witch indicates idle or busy in any of the first channels and the second channel during the period of radio communication by using the second channel.

5. The radio communication apparatus according to claim 1, wherein the information represents throughput during the period of radio communication by using the one of first channels and throughput during the period of the radio communication by using the second channel.

6. The radio communication apparatus according to claim 1, wherein the information represents a frame transmission success rate during the period of radio communication by using the one of first channels and a frame transmission success rate during the period of the radio communication by using the second channel.

7. The radio communication apparatus according to claim 1, wherein
the acquiring device is a receiving device configured to receive a change request for the first period length making the radio communication by using one of the first channels and for the second period length making the radio communication by using the second channel; and
the information represents the change request.

8. A radio communication method, comprising:
acquiring information required to determine a ratio between a first period length making a radio communication by using either of two first channels each having a first bandwidth and a second period length making a radio communication by using a second channel having a second bandwidth wider than the first bandwidth, the second channel overlapping with the two first channels;
determining the ratio on the basis of the information, thereby determining the first period length and the second period length; and
making a radio communication by using the first channel within the first period length and making a radio communication by using the second channel within the second period length.

9. The radio communication method according to claim 8, wherein the information represents the number of terminals making radio communications by using one of the first channels and the number of terminals making radio communications by using the second channel.

10. The radio communication method according to claim 8, wherein the information represents a traffic amount of the radio communication using one of the first channels and a traffic amount of the radio communication using the second channel.

11. The radio communication method according to claim 8, wherein the information represents at least one state which indicates idle or busy in any of the first channels and the second channel during the period of radio communication by using one of the first channels, and at least one state in any of the first channels and the second channel during the period of radio communication by using the second channel.

12. The radio communication method according to claim 8, wherein the information represents throughput during the period of radio communication by using one of the first channels and throughput during the period of radio communication by using the second channel.

13. The radio communication method according to claim 8, wherein the information represents a frame transmission success rate during the period of radio communication by suing one of the first channels and a frame transmission success rate during the period of radio communication by using the second channel.

14. The radio communication method according to claim 8, wherein said acquiring includes receiving a change request for the first period length making the radio communication by using one of the first channels and for the second period length making the radio communication by using the second channel; and the information represents the change request.

15. A computer program stored in a computer-readable medium for radio communication processing, the program comprising:
means for instructing a computer to acquire information required to determine a ratio between a first period length making a radio communication by using either of two first channels each having a first bandwidth and a second period length making a radio communication by using a second channel having a second bandwidth wider than the first bandwidth, the second channel overlapping with the two first channels;
means for instructing the computer to determine the ratio on the basis of the information, thereby to determine the first period length and the second period length; and
means for instructing the computer to make a radio communication by using the first channel within the first period length and to make a radio communication by using the second channel within the second period length.
